(19) United States
(12) Patent Application Publication
(10) Pub. No.: US 2025/0307685 A1
(43) Pub. Date: Oct. 2, 2025

(54) GENERATION OF MODIFIED QUANTUM ERROR CORRECTION CODES FOR QUANTUM PROCESSORS WITH COMPONENT FAILURES

(71) Applicant: Google LLC, Mountain View, CA (US)

(72) Inventors: Adam Jozef Zalcman, Tokyo (JP); Nathan Cody Jones, Los Angeles, CA (US); Kevin Joseph Satzinger, Goleta, CA (US); Andrew Lorne Dunsworth, Santa Barbara, CA (US)

(21) Appl. No.: 18/621,958

(22) Filed: Mar. 29, 2024

(51) Int. Cl. G06N 10/70; G06N 10/40; G06N 10/60

(52) U.S. Cl. CPC G06N 10/70; G06N 10/40; G06N 10/60

(57) ABSTRACT

A method for operating a quantum error correction (QEC) code on a quantum computing system (QCS) is disclosed. The QCS includes a set of qubits and a set of couplers. An indication of a set of dropouts is received. Each dropout corresponds to a qubit that is non-functional or a coupler that is non-functional. The dropouts define a set of non-functional qubits, a set of functional qubits, a set of non-functional couplers, and a set of functional couplers. The QEC code is generated based on a set of heuristics, the set of functional qubits, and the set of functional couplers. The QEC code operates on the functional qubits. Each functional coupler provides a coupling between a pair of functional qubits. A quantum algorithm is executed that includes employing the QEC code to protect a set of logical qubits formed by the first subset of functional qubits from logical errors.

### FIELD

The present disclosure relates generally to quantum computing and information processing systems, and more particularly to the generation of subsystem surface codes for quantum processors with component failures.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b |1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a method for operating a quantum computing system (QCS). The QCS may include a set of qubits and a set of couplers. The method includes receiving an indication of a set of dropouts. Each dropout of the set of dropouts corresponds to a separate qubit of the set of qubits that is a non-functional qubit or a separate coupler of the set of couplers that is a non-functional coupler. The set of dropouts defines a set of non-functional qubits, a set of functional qubits that is disjoint from the set of non-functional qubits, a set of non-functional couplers, and a set of functional couplers that is disjoint from the set of non-functional couplers. A quantum error correction (QEC) code is generated based on the set of dropouts and a set of heuristics. The QEC code operates on a first subset of the set of functional qubits. Each functional coupler of a first subset of the set of functional couplers provides a coupling between a separate pair of functional qubits of the first subset of functional qubits. A quantum algorithm is executed on the QCS. Executing the quantum algorithm includes employing the QEC code to protect a set of logical qubits formed by the first subset of functional qubits from logical errors.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure;

FIG. 2A shows a distance-5 valid surface code implemented on a set of qubits without component failures, according to various example embodiments of the present disclosure;

FIG. 2B shows a distance-5 invalid surface code implemented on a set of qubits with component failures, according to various example embodiments of the present disclosure;

FIG. 2C shows a distance-3 invalid surface code implemented on the set of qubits 240 with component failures, according to various example embodiments of the present disclosure;

FIG. 3A shows generating a valid surface code on a set of qubits that includes dropouts, according to some rigid grid example embodiments of the present disclosure;

FIG. 3B depicts a flow chart diagram of an example method for operating a quantum computing device, according to various e example embodiments of the present disclosure;

FIG. 3C depicts a flow chart diagram of an example method for generating a quantum error correction code, according to various example embodiments of the present disclosure;

FIG. 3D depicts a flow chart diagram of an example method for fusing qubit dropouts to boundaries of a quantum error correction code, according to various example embodiments of the present disclosure;

FIG. 4 shows generating a modified surface code on a set of qubits that include dropouts, according to some loss-resistance example embodiments of the present disclosure;

FIG. 5 shows generating a modified surface code when dropouts are present, according to various example embodiments of the present disclosure;

FIG. 6 shows generating another modified surface code when dropouts are present, according to various example embodiments of the present disclosure; and

FIG. 7 shows generating a first modified surface code and a second modified surface code when dropouts are present, according to various example embodiments of the present disclosure.

### DETAILED DESCRIPTION

Example aspects of the present disclosure are directed to methods, architectures, and hardware configurations for generating and implementing quantum error correction (QEC) codes (e.g., modified surface codes and surface-like codes) on a quantum computing system (QCS), when one or more hardware component failures occur in the QCS. In the discussion throughout, a hardware component failure (or simply a component failure) refers to one or more faulty qubits and/or one or more faulty qubit couplers. Throughout, a hardware component failure may be referred to as a dropout (e.g., a qubit dropout or a coupler dropout). Also throughout, the term qubit may refer to a physical qubit (e.g., a transmon qubit). The generated QEC code forms logical qubits comprised of multiple functional physical qubits. The QEC code protects the logical qubits from logical errors by detecting and correcting physical errors occurring in the underlying physical qubits (e.g., qubits). Also, in the discussion throughout, a surface code (or surface-code like) QEC code is assumed. However, the embodiments are not limited to surface codes and/or surface-code like QECs, and other QECs are contemplated via the embodiments.

A leading proposal for the fault-tolerant quantum computer envisages a two-dimensional grid of physical (e.g., superconducting) qubits with nearest-neighbor connectivity running a high-threshold QEC code (e.g., a surface code). The embodiments provide sufficient connectivity achievable in modern physical qubit technology on one hand and the connectivity required to implement a QEC code on the other hand. Unfortunately, fabrication of quantum processors is imperfect and often yields devices in which some components, such as a portion of the qubits and/or couplers, are damaged or broken. Similarly, calibration of quantum processors often results in operating parameters that leave certain qubits or couplers prone to runtime errors. Thus, in the embodiments, qubits and/or couplers that are prone to runtime errors may be deactivated and considered as non-functional (e.g., dropouts). These issues pose a challenge for implementing QEC codes, such as surface codes, to realize practical fault-tolerant quantum computation.

The embodiments provide quantum circuits that implement a modified QEC code (e.g., a modified surface code) on a processor with broken qubits and/or broken qubit couplers. More particularly, the embodiments automatically generate and implement (via quantum circuits) a modified QEC code that is valid (e.g., preserves code invariants that are required so that the QEC code can sufficiently protect logical qubits from logical errors). The modified QEC code is “mapped” around the hardware dropouts (e.g., inoperable components). Some embodiments remove quantum gates incident on the inoperable components. This changes the footprint of some of the observables making up the code which may lead to two pathologies. First, some pairs of observables (e.g., observables associated with check operators of stabilizers of a surface code) fail to commute. Consequently, their simultaneous measurement, necessary for the operation of the QEC code, becomes impossible due to the Heisenberg uncertainty principle. Second, topological holes may open up in the bulk of the QEC code as a result of broken qubits (e.g., qubit dropouts). Such topological holes can reduce the code distance, making it susceptible to significantly more errors, and inadvertantly increase the dimension of the encoded subspace.

The embodiments cure the first pathology, e.g., a pair of non-commuting observables, by eliminating one of the offending observables. The choice of the observable to remove is made based on a set of heuristics that aim to restore the appropriate boundary while maximizing the code distance. The embodiments cure the second pathology, e.g., a hole in the bulk, by replacing the local quantum processing made impossible by broken components with classical processing. More particularly, the embodiments employ quantum circuits to measure gauge operators instead of stabilizer operators and combine the measurement outcomes classically to produce composite (or synthetic) stabilizer operators (aka composite and/or synthetic check operators). This effectively forms a topological vacuum over the hole, restoring the dimension of the encoded subspace and partially restoring the code distance. Some embodiments may implement these techniques by operating on an error graph flattened along the time axis and extended with fictitious nodes along boundaries.

Some embodiments receive an indication of dropouts. Based on the pattern of the dropouts, the embodiments generate a surface-code like QEC code (e.g., a subsystem surface code or other QEC code) that “maps around” the hardware failures. The generated QEC code protects the logical qubits (e.g., that are “mapped around” the non-functional qubits and non-functional qubit couplers) from errors occurring during the execution of a quantum calculation. Generating the “modified” QEC code (e.g., that is mapped around the hardware dropouts) is based on the pattern of dropouts and a set of heuristics. As used herein, the term modified (e.g., when used in reference to a QEC code) refers to one or more modifications from an underlying QEC code (e.g., a surface code). The modifications may refer to “mapping around” the hardware failures, such that quantum algorithms can safely (e.g., without logical errors) be executed on a set of hardware (e.g., a set of qubits and a set of couplers) that has known and/or characterized failures (e.g., fabrication defects). The modifications to the QEC code preserve various code invariants, such that the code is still a “valid” code (e.g., that the modified code can still detect and correct quantum errors such that the results of a quantum computation can be relied upon).

For surface code and surface-code like embodiments, such code invariants include pairs of parity check operators of the QEC code commute. For some dropout patterns, to preserve the commutation of check operators code invariants, gauge operators may be formed. A gauge operator is a quantum operator that functions as a piece of a stabilizer. A gauge operator may detect errors when used in combination with other gauge operators. Measurements of gauge operators may be random even when no errors occur. This means, for example, that comparing two consecutive measurements of the same gauge operator cannot reliably detect errors. However, stabilizers (or detectors) can be formed by combinations of measurements across gauge operators, which is why they act as “pieces” of stabilizer. Thus, two or more gauge operators can be combined to form a “composite” stabilizer in a QEC code, such as a modified surface code. The check operator formed by a composite stabilizer (e.g., a combination of check operators of two of more gauge operators) may commute with all the other check operators of the modified QEC code, including the check operators of other composite stabilizers of the modified QEC code. Thus, the code invariant that guarantees the commutation of all pairs of check operators is preserved in the modified QEC code. Another code invariance for surface code embodiments that is preserved in a modified QEC code is that the modified QEC code has four topological corner qubits.

One example embodiment is directed to a method for operating a QCS. The QCS may include a set of qubits and a set of couplers. The method includes receiving an indication of a set of dropouts. Each dropout of the set of dropouts corresponds to a separate qubit of the set of qubits that is a non-functional qubit or a separate coupler of the set of couplers that is a non-functional coupler. The set of dropouts includes a set of coupler dropouts corresponding to the set of non-functional couplers. The set of dropouts may include a set of qubit dropouts corresponding to the set of non-functional qubits. The set of dropouts defines a set of non-functional qubits, a set of functional qubits that is disjoint from the set of non-functional qubits, a set of non-functional couplers, and a set of functional couplers that is disjoint from the set of non-functional couplers. Each non-functional qubit of the set of non-functional qubits may be deactivated. Each non-functional coupler of the set of non-functional couplers may be deactivated. A (modified) QEC code is generated based on the set of dropouts and a set of heuristics. That is, a QEC code may be (automatically) modified based on the pattern of dropouts and the set of heuristics. The QEC code operates on a first subset of the set of functional qubits. Each functional coupler of a first subset of the set of functional couplers provides a coupling between a separate pair of functional qubits of the first subset of functional qubits. A quantum algorithm is executed on the QCS. Executing the quantum algorithm includes employing the QEC code to protect a set of logical qubits formed by the first subset of functional qubits from logical error. Various code invariants are preserved in the modification of the QEC code, such that the automatically modified QEC code is a “valid” code that provides sufficient mitigation of quantum errors during the execution of the quantum algorithm.

Generating the QEC may include adding additional qubit dropouts to the set of qubit dropouts based on the set of coupler dropouts and a first heuristic of the set of heuristics. A set of boundaries of the QEC code may be defined based on the set of qubit dropouts. The set of qubit dropouts is subdivided into a set of boundary dropouts and a set of bulk dropouts based on the set of boundaries. At least a portion of the set of qubit dropouts may be fused to a boundary of the set of boundaries. The QEC code is generated to exclude (e.g., map around) qubits of the set of qubits that correspond to the set of bulk dropouts and the set of boundary dropouts.

More particularly, the QEC code subdivides the set of functional qubits into a set of data qubits and a set of check qubits that is disjoint from the set of data qubits. Each coupler of the set of couplers provides coupling between a data qubit of the set of data qubits and a check qubit of the set of check qubits. That is, each coupler of the set of couplers is associated with a data qubit of the set of data qubits and a check qubit of the set of check qubits.

Aspects of the present disclosure provide a number of technical effects and benefits. For instance, the embodiments may be employed to generate and implement modified QEC codes that may be employed on quantum hardware that has defects (e.g., broken qubits and/or broken qubit couplers). The modifications to the QEC codes are performed automatically. As code distances scale and/or the density of hardware defects (e.g., dropouts) becomes large, manually generating a modified QEC becomes cumbersome and even impractical. Thus, the automated tools of the embodiments obviate the need for manual intervention when designing QEC codes that take into account hardware defects.

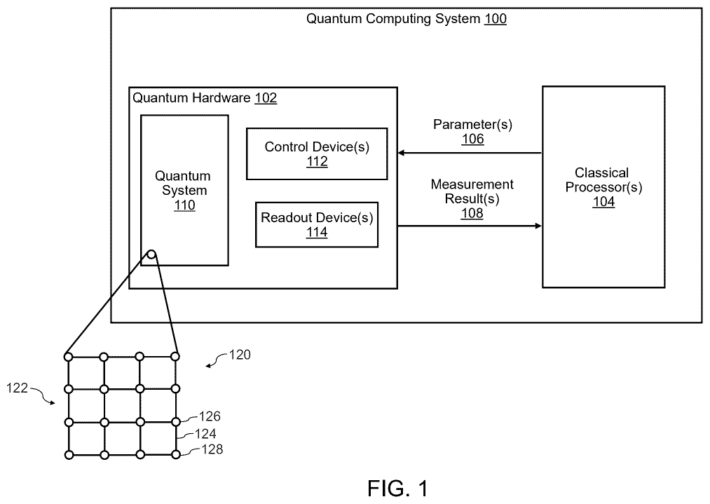

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots, or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit, and the control device(s) 112 and readout devices(s) 114 may implement one or more quantum logic gates that operate on the quantum hardware 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameters 106 from the classical processors 104. The quantum hardware 102 may use the received physical control qubit parameters 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0 [symbol] and |1 [symbol] states of an element of the quantum system 110, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the quantum system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.

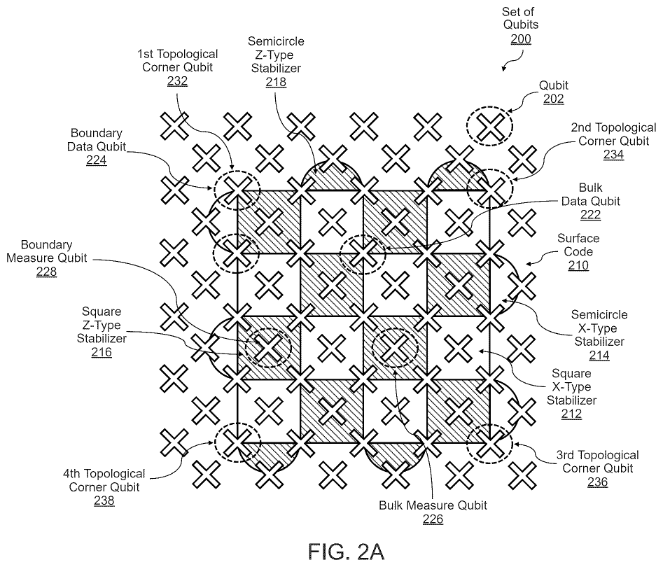

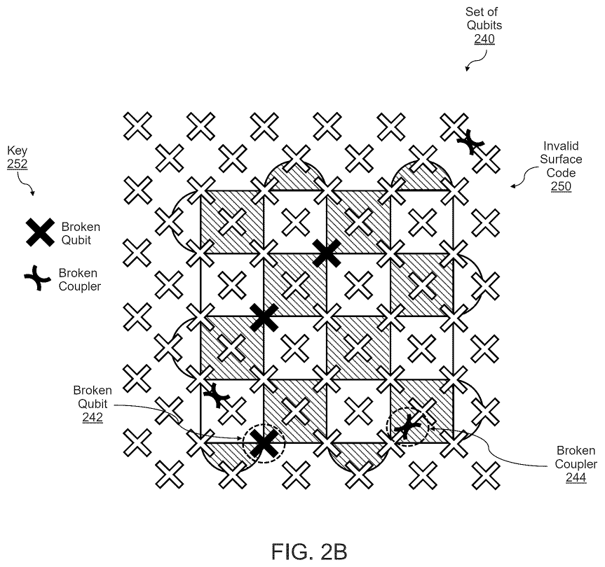

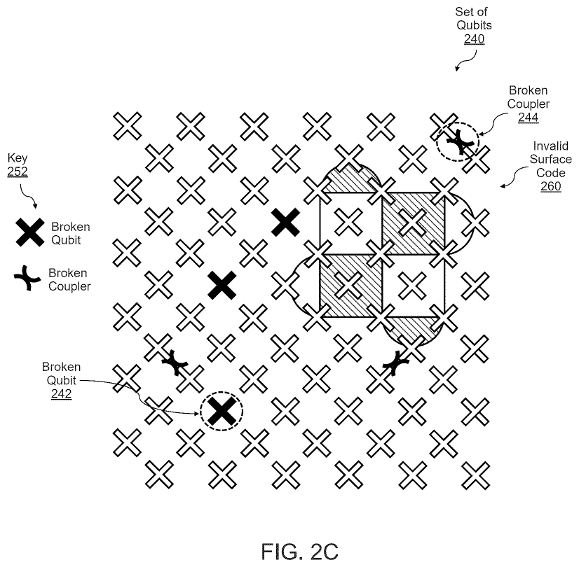

FIG. 2A shows a distance-5 surface code 210 implemented on a set of qubits 200 without component failures, according to various embodiments. Each qubit of the set of qubits 200 is represented by an unfilled (or hollow) “X” token (e.g., qubit 202). The set of qubits 200 is arranged in a staggered 2D grid. In the staggered 2D grid of qubits, consecutive columns of qubits have a relative vertical offset and consecutive rows of qubits have a relative horizontal offset. That is, every other row of qubits is associated with a first absolute horizontal offset (e.g., 0) and the rows between these rows with the first horizontal offset have an absolute second horizontal offset (e.g., Δ_{H}). Likewise, every other column of qubits is associated with an absolute first vertical offset (e.g., 0) and the columns between these columns with the first vertical offset have an absolute second vertical offset (e.g., Δ_{V}). A set of qubit couplers is included, but not shown explicitly in FIG. 2A, for the set of qubits 200. A qubit coupler may couple “nearest neighboring” qubits. That is, qubit couplers may couple a qubit to each of its four “nearest neighbors.” Note that a qubit's four nearest neighbors are located along “diagonal” lines, with respect to the vertical and horizontal columns and rows of the 2D grid. Thus, the qubit couplers may be oriented diagonally with respect to the horizontal rows and vertical columns. A qubit can be coupled to two qubits in the column to the “left” of the qubit's column and to two qubits in the column to the “right” of the qubit's column via four separate qubit couplers. This may be alternatively stated as the qubit may be coupled to two qubits in the row “above” the qubit's row and to two qubits in the row “below” the qubit's row. In some non-limiting embodiments, a qubit coupler may additionally couple “horizontally neighboring” qubits (e.g., two horizontally consecutive qubits in the same row of qubits). A qubit coupler may additionally couple “vertically neighboring” qubits (e.g., two vertically consecutive qubits in the same column of qubits).

The surface code 210 may include a set of stabilizers. Throughout, a stabilizer may be referred to as a “check,” because they are employed to check the parity of data qubits. Thus, a surface code may have a set of checks. Each stabilizer (or check) of the set of stabilizers (or checks) has a corresponding operator, such that a set of operators is formed. In a proper surface code (e.g., surface code 210), each operator of the set of operators may commute with each other operator of the set of operators. More particularly, the set of stabilizers includes a set of X-type stabilizers (or X checks) and a set of Z-type stabilizers (or Z checks). X checks are employed to check the “X-parity” of data qubits and Z checks are employed to check the “Z-parity” of data qubits. Each X-type stabilizer (e.g., a X check) of the set of X-type stabilizers includes two or four Pauli-X operators (e.g., XX or XXXX) and each Z-type stabilizer (e.g., a Z check) of the set of Z-type stabilizers includes two or four Pauli-Z operators (e.g., ZZ or ZZZZ). As described below, each X in the XXXX operator or the XX operator is associated with a separate data qubit of the X-type stabilizer. Each Z in the ZZZZ operator or the ZZ operator is associated with a separate data qubit of the Z-type stabilizer. X-type and Z-type stabilizers (e.g., X-checks and Z-checks) may share one or more data qubits. However, each stabilizer of the set of stabilizers has its own measure (or ancilla) qubit. Because the operator associated with a stabilizer is employed to check the parity (e.g., X-type parity or Z-type parity), the operator may be referred to as a check operator. Furthermore, since each measure (or check) qubit is associated with a single stabilizer, each measure (or check) qubit has an associated check operator. The weight of an operator (e.g., a check operator) has a weight equivalent to the number of Pauli-operators the operator includes (or equivalently, the number of data qubits included in the associated stabilizer). Thus, the weight of the check operators described above is either two or four, depending on how many X-type or Z-type operators are included. Thus, a check operator has a type and/or flavor (e.g., X-type or Z-type) and a weight. Although the check operators discussed above have weight two or four, the embodiments are not so limited, and the check operators of various embodiments may have weights that differ from two or four. Some check operators may have an odd weight.

In FIG. 2A, the X-type stabilizers are represented by “white” tiles (or plaquettes), while the Z-type stabilizers are represented by the “dark” tiles (or “plaquettes”). Note that there are “square” plaquettes of each stabilizer type and “semicircle” plaquettes of each stabilizer type. The square stabilizers (i.e., the stabilizers corresponding to the square plaquettes) form a “checkerboard” pattern of X-type and Z-type square stabilizers (e.g., square checks). Semicircle X-type stabilizers are positioned on the two vertical boundaries of the surface code 210, while semicircle Z-type stabilizers are positioned on the two horizontal boundaries of the surface code 210. The semicircle stabilizers may be referred to as “ear” stabilizers (e.g., semicircle checks or ear checks).

Each square stabilizer (e.g., square X-type 212 and square Z-type stabilizer 216) corresponds to five qubits: one qubit at each of the four corners (or vertices) of the square plaquette and one qubit in the center of the square plaquette). The four “vertex” qubits are “data” qubits, while the qubit in the center of the square plaquette is a “measure” (or ancilla) qubit. For reasons discussed below, a measure qubit may be referred to as a check qubit. For shorthand, a data qubit may be indicated as a “dq” and a measure (or check) qubit may be referred to as a “cq.” Each semicircle (or “ear”) stabilizer (e.g., semicircle X-type stabilizer 214 and semicircle Z-type semicircle 218) corresponds to three qubits: two “antipodal” qubits on the diameter of the semicircle plaquette and a qubit in the middle of the semicircle arc. The two antipodal qubits are data qubits, while the qubit in the middle of the semicircle arc is a measure qubit. Thus, each row of qubits is either a row of data qubits or a row of measure qubits. Likewise, each column of qubits is either a column of data qubits or a column of measure qubits. The rows of data qubits and the rows of measure qubits are alternating in the staggered 2D grid, such that the rows of data qubits have the first horizontal offset, and the rows of measure qubits have the second horizontal offset. The columns of data qubits and the columns of measure qubits are alternating in the staggered 2D grid, such that the columns of data qubits have the first vertical offset, and the columns of measure qubits have the second vertical offset.

Data qubits may be a bulk data qubit (e.g., bulk data qubit 222), a boundary data qubit (e.g., boundary data qubit 224), or a topological corner qubit (e.g., first topological corner qubit 232). Note that bulk data qubits (e.g., bulk data qubit 222) are included in (or touch) two X-type square stabilizers and two Z-type stabilizers. A boundary data qubit (e.g., boundary data qubit 224) may be included in (or touch) two stabilizers of the same type (X-type or Z-type stabilizers) and included in (or a touch) a single stabilizer of the other type. Note that of the two stabilizers of the same type, one stabilizer is a square stabilizer on the boundary and the other stabilizer is a semicircle stabilizer on the boundary. The single stabilizer type is a square stabilizer on the boundary. A topological corner (data) qubit (e.g., first topological corner qubit 232) may be included in (or touch) a semicircle stabilizer of one type (e.g., X-type or Z-type semicircle stabilizer) and a square stabilizer of the other type (e.g., a Z-type or X-type square stabilizer). A valid surface code (e.g., surface code 210) encoding a single logical qubit must have exactly four topological corner (data) qubits, e.g., first topological corner qubit 232, second topological corner qubit 234, third topological corner qubit 236, and fourth topological corner qubit 238. Note that each topological corner qubit is a data qubit. For simplicity, unless otherwise indicated the term “corner qubit” may refer to a topological corner qubit: i.e., a data qubit protected by exactly one X-type check (or X-type stabilizer) and exactly one Z-type check (or Z-type stabilizer).

Likewise, a measure qubit may be a bulk measure qubit (e.g., bulk measure qubit 226) or a boundary measure qubit (e.g., boundary measure qubit 228). Each measure qubit is included in a single stabilizer. The operator of a stabilizer is associated with the four (for square stabilizers) or two (for semicircle stabilizers) data qubits of the stabilizer. For instance, the operator for the square X-type stabilizer 212 is XXXX, where each of the X's of the operator XXXX is a Pauli-X operator and associated with a separate data qubit of the four data qubits of the square X-type stabilizer 212. The operator for the semicircle X-type stabilizer 214 is XX, where each of the X's of the operator XX is a Pauli-X operator and associated with a separate data qubit of the two data qubits of the semicircle X-type stabilizer 214. The operator for the square Z-type stabilizer 216 is ZZZZ, where each of the Z's if the operator ZZZZ is a Pauli-Z operator and associated with a separate data qubit of the four data qubits of the square Z-type stabilizer 216. The operator for the semicircle Z-type stabilizer 218 is ZZ, where each of the Z's of the operator ZZ is a Pauli-Z operator and associated with a separate data qubit of the two data qubits of the semicircle Z-type stabilizer 218.

Due to the commutation relationships between Pauli operators and to ensure that each stabilizer of the set of stabilizers commutes with each other stabilizer of the set of stabilizers, each stabilizer of a first type (X-type or Z-type) shares an even number (e.g., 0 or 2) data qubit with each other stabilizer of the second type (Z-type or X-type). The even-number of shared data qubits among each pair of stabilizers ensures the commuting properties of the corresponding operators. Note that the topology of the surface code 210 relies on the set of qubits 200 having no non-functional or “broken” qubits (or broken qubit couplers) in the 2D grid. If there are non-functional or broken qubits (or qubit couplers) in the 2D grid, the set of qubits 200 may be said to have dropouts and/or component failures. The distance (d) of a surface code may be defined as the minimal number of data qubits that must be traversed to connect one boundary data qubit from a first boundary (e.g., the first topological corner qubit 232) to another boundary data qubit on a second boundary that opposes the first boundary (e.g., the second topological corner qubit 234 or the fourth topological corner qubit 238).

FIG. 2B shows a distance-5 invalid surface code 250 implemented on a set of qubits 240 with component failures, according to various embodiments. The set of qubits 240 may be arranged in a staggered 2D grid similar to the set of qubits 200 of FIG. 2A. However, unlike the set of qubits 200 of FIG. 2A, the set of qubits 240 in FIG. 2B has non-functional qubits and non-functional qubit couplers. That is, the set of qubits 240 has broken qubits and broken qubit couplers, such that it may be said that the set of qubits 240 has dropouts and/or component failures. The term “dropout” may be used throughout to refer to a qubit or a qubit coupler that is non-functional and/or is otherwise broken. The key 252 in FIG. 2B indicates that the broken qubits (e.g., broken qubit 242) are shown as filled “X” tokens and the broken qubit couplers (e.g., broken coupler 244) are shown as filled “coupler” tokens. For simplicity, the functional qubit couplers in the 2D grid are not shown explicitly in FIG. 2B. An encoding of which qubits and which qubit couplers of a set of qubits are broken, non-functional, and/or non-operational may be referred to as a “pattern of component failures” for the set of qubits. As indicated throughout, broken qubits and/or broken qubit couplers may be referred to as dropouts.

The surface code 250 is invalid because the surface code 250 is non-functional (or faulty) due to the pattern of component failures for the set of qubits 240. No translation and/or rotation of the set of qubits 240 across the 2D grid would enable a proper functioning distance-5 surface code on the set of qubits 240.

The embodiments are directed towards generating modified quantum error correction (QEC) codes that “map around” dropouts (e.g., non-functional qubits and/or qubit couplers), but still provide adequate quantum error detection and correction services in a quantum computing systems (QCS). The QEC codes considered in the following discussion are surface codes (or surface-code like codes), similar to the ones discussed in FIGS. 2A-2C. However, the embodiments are not so limited and other QEC codes are contemplated via the embodiments. In the context of surface and surface-like codes, the modified QEC code that is generated in response to one or more dropouts is referred to as a subsystem surface code. Generating a modified QEC code is based on a set of heuristics and the pattern of dropouts in the set of qubits and the set of qubit couplers. The methods employed to generate a modified QEC code preserve code invariants, i.e., relationships between code elements that must remain true for the code to be a valid QEC code. For instance, one code invariant that is preserved in the modified QEC codes (e.g., a subsystem surface code) is that all the check operators (e.g., the operators associated with the stabilizers) commute pairwise. The term “conflicting checks” may be employed to refer to check operators that don't commute. For instance, for a QEC code to be valid, no pair of check operators may be a conflicting check. The modified QEC codes generated by the embodiments are valid codes. That is, in the modified codes generated by the embodiments, no conflicting checks exist. The methods of generating a valid modified QEC code come in two general flavors: rigid grid embodiments and loss-resistance embodiments.

FIG. 2C shows a distance-3 invalid surface code 260 implemented on the set of qubits 240 with component failures, according to various embodiments. The set of qubits 240 in FIG. 2C is the same set of qubits 240 in FIG. 2B, with the same pattern of component failures. The broken qubit 242 and the broken qubit coupler 244 are shown in FIG. 2C. FIG. 2C is shown to indicate that a smaller distance code (d=3) may be implemented when a pattern of component failures renders a larger surface code (e.g., d=5) non-implementable on the set of qubits 240. Note that, in general, a surface code with a larger distance is more robust to detecting and correcting errors with a smaller distance. For instance, a d=5 surface code (e.g., surface code 210 of FIG. 2A) is more robust than a d=3 surface code (e.g., surface code 260 of FIG. 2C).

When dropouts are present in a set of qubits, the embodiments employ a set of heuristics and the dropout pattern in the set of qubits to automatically generate a surface code and/or a subsystem surface code. In some embodiments, the embodiments may generate a surface code, with the same distance as would be implemented without the dropouts, via a translation and/or rotation of the surface code position and/or rotational orientation, with respect to the set of qubits. Embodiments that translate and/or rotate the positional and/or orientation of the surface code may be referred to as rigid grid embodiments. Other embodiments modify that surface to make it work despite qubit and qubit coupler loss. Such modification embodiments may be referred to as loss-resistance embodiments.

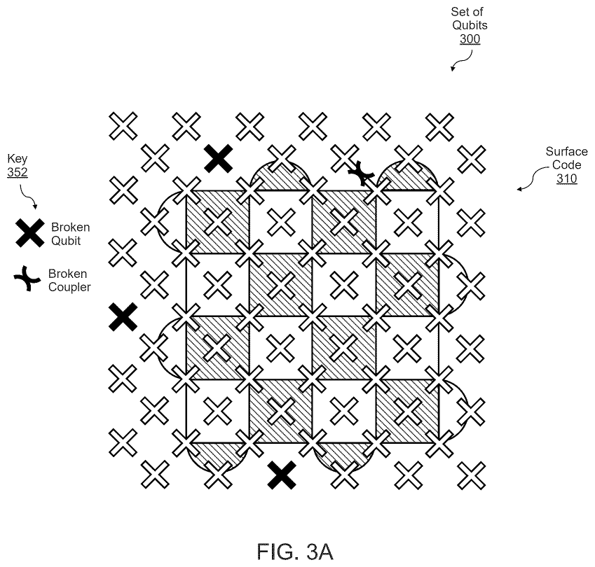

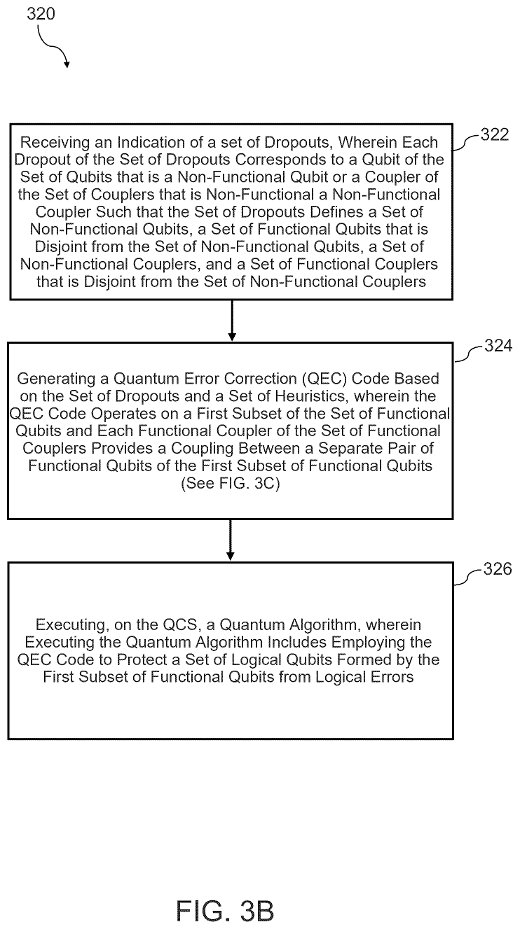

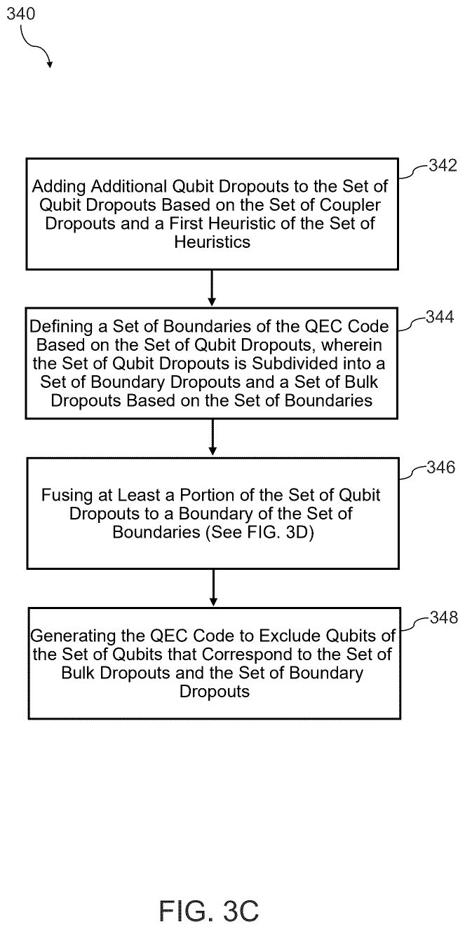

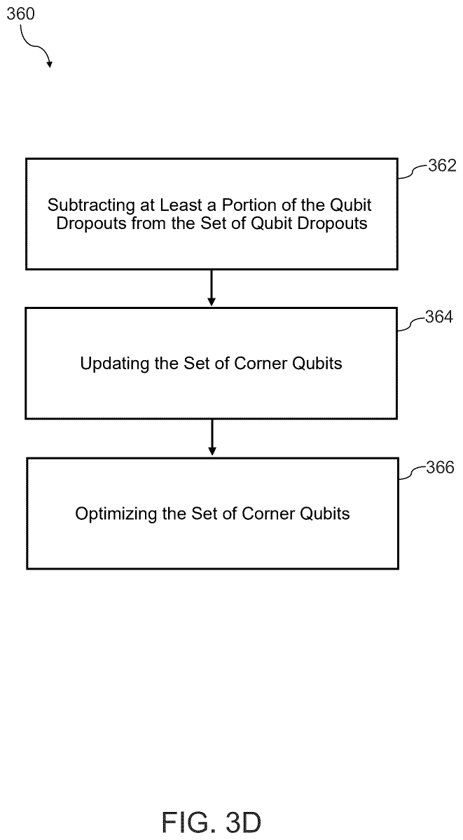

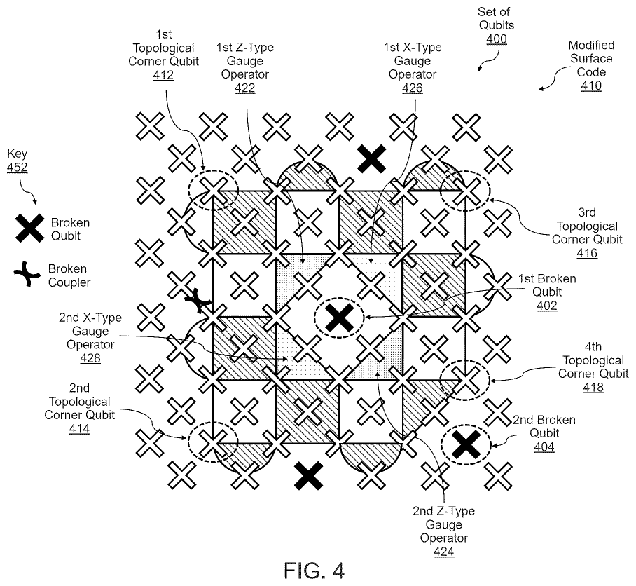

FIG. 3A shows generating a valid surface code 310 on a set of qubits 300 that includes dropouts, according to some rigid grid embodiments. As shown in FIG. 3A, the set of qubits 300 has a set of dropouts. However, the d=5 surface code 310 is implementable by translating the d=5 surface code 310 over the set of qubits 300 such that none of the qubits or qubit couplers dropouts are included in the d=5 surface code 310. Note that in a rigid grid strategy, such as that shown in FIG. 3A, circuit generation and syndrome decoding are unaffected via the translation and/or rotation of the surface code. However, as shown in FIG. 4, a rigid grid strategy may not be implemented for every pattern of dropouts, at least without reducing the code distance, such as the dropout pattern shown in FIGS. 2B-2C, where a d=5 code could not be constructed, but a d=3 code could. For such patterns, where a reduction in code distance is to be avoided, a loss-resistance strategy is employed.

For loss-resistance embodiments, generating a modified valid code is based on the pattern of dropouts and a set of heuristics. A dropout can be a qubit dropout or a qubit coupler dropout. Two types of qubit dropouts exist: bulk dropouts and boundary dropouts. Boundary dropouts are non-functional qubits located on a boundary of the surface (or subsystem surface) code. Bulk dropouts are non-functional dropouts located within the boundary of the surface (or subsystem surface) code. Methods implementing loss-resistance embodiments have three stages. In the first stage, coupler dropouts are reduced to qubit dropouts, such that the pattern of dropouts includes qubit dropouts only. In the second stage, the (qubit) dropouts are fused to the boundaries of the code. In the third stage, dropouts in the bulk (e.g., bulk dropouts) are handled. The details of the three steps are discussed in detail below. However, briefly here, the second stage includes three steps. In the second stage, where dropouts are fused, first dropouts are subtracted, then the corners are fixed, and then the corners are optimized. As a reminder, a corner may refer to a data qubit that is protected by exactly one Z-type check operator (e.g., associated with a Z-type stabilizer) and exactly one X-type check operator (e.g., associated with a X-type stabilizer).

Because couplers couple qubits along a diagonal, at least a portion of the couplers couple a data qubit and a check (or measure) qubit. In the discussion throughout, a coupler may be indicated by the index (c), a data qubit may be indicated by the index (dq), and a check qubit may be indicated by the index (cq). Accordingly, a coupler's relationship between a pair of qubits (e.g., a data qubit and a check qubit) may be indicated by the two-tuple: c=(dq, cq). That is, coupler (c) connects data qubit (dq) and check qubit (cq). In the first stage of a loss-resistance embodiment, coupler dropouts are reduced to qubit dropouts. In doing so, a decision is made to deactivate at least one of the data qubit or the check qubit associated with the broken coupler. To make this decision, the following heuristic is used. If at least one of the qubits (dq and/or cq) associated with the broken coupler (c) is also broken, deactivate the broken qubit and return. Otherwise, if the check operator of the functional check qubit has a weight of 2, deactivate the check qubit and return. Otherwise, deactivate the functional data qubit and return.

In the second stage of a loss-resistance embodiment, dropouts are fused to a boundary. As noted above, fusing dropouts includes three steps: subtracting dropouts (which are all qubit dropouts via the first stage), fixing corners, and optimizing corners. The subtracting dropouts step includes two sub-steps. In the first sub-step of subtracting dropouts, the dropout (or non-functioning) qubits are removed. In the second sub-step of subtracting dropouts, code invariant elements that were broken via the removal of dropout qubits are repaired. Repairing code invariants is performed iteratively until all code invariants are restored. A single iteration of repairing code invariants is performed via two sequential processes: a pruning process and a conflict resolution process. The pruning process eliminates, removes, and/or prunes functional data qubits that are insufficiently protected to remain in the code. Pruning also includes eliminating, removing, and/or pruning functional check qubits that correspond to check operators that fail to act on at least two data qubits still in the code. The conflict resolution process examines all pairs of anti-commuting check operators and removes one check operator from each non-commuting pair. In a single iteration of the conflict resolution process, each pair of surviving check operators is examined. A pair of check operators is labeled as a conflicting pair if the two check operators in a pair do not commute. For a resulting set of conflicting pairs, each conflicting pair is examined. The following heuristic may be applied to resolve conflicts (e.g., non-commuting check operators). For a particular conflicting pair, if one of the included check operators conflicts with another check operator (of the other check operators), then that check operator is removed and the conflict resolution process is terminated for that pair. Otherwise, the effect of removing each check operator of the particular conflicting pair is examined. More particularly, the effect that each potential removal will have on corner formation is examined. This is done approximately by operating on corner polygons. A corner polygon is a stabilizer, tile, or plaquette, whose vertices correspond to a corner qubit (e.g., a topological corner qubit). If the current connected component needs a new corner and dropping or removing one of the conflicting check operators forms a corner, then the check operator is dropped. Otherwise, an estimate of the code distance for each logical observable is generated. Then, the check operator that leads to corners with the highest possible code distance estimate is dropped or removed.

The second step of fusing dropouts to a boundary includes fixing corners. To fix corners, first, all connected components are found, and the circumference of the connected components is calculated. All the found connected components except the one with the highest boundary circumference are removed and/or deleted. As noted above, a code invariant is that a valid code must have exactly four corner qubits. Thus, the number of corner qubits (k) in the remaining connected components is counted. If k>4, then some corners are removed. If k<4, then new corners are formed. If k=4, then the second sub-step is terminated. To remove corners (e.g., when k>4), the following heuristic may be employed. First, corners that are not protected by a weight-4 stabilizer are removed. After unprotected corners are removed, each valid 4-corner polygon formed by selecting four qubits from the current corners are examined. Similarly, to the steps of conflict resolution discussed above, a code distance estimated is determined for each possible set of four corners. The set of four corners with the highest code distance is selected. Finally, a set of checks that must be removed to annihilate the corners not selected is determined. The non-selected corners may be removed. To form new corners (e.g., when k<4), the following heuristic may be employed. If there are no corners at all, then a weight-2 check may be removed and/or deleted. This scenario may appear somewhat innocuous since one of the checks is the product of all the other checks of the same type. If there are two corners, all locations along the boundary where two new corners could be formed by removing checks may be considered. Similar to the conflict resolution process, a code distance estimate for each possible new location of the corners may be determined. The new location of a corner with the highest code distance is selected for a new corner.

The third step of fusing dropouts to a boundary includes optimizing corners. To optimize the corners, a code distance estimate corresponding its new possible location that is obtained by removing the weight-2 check incident on the corner is computed. The weight-2 check may be removed if the code distance estimate exceeds the current code distance.

In the third stage of a loss-resistance embodiment, bulk dropouts are handled. More particularly, in this stage, bulk dropouts which have not been fused to a boundary by the logic of phase two are handled using a subsystem code. In some embodiments, no heuristics are needed here.

### Example Methods

FIG. 3B depicts a flow chart diagram of an example method 320 for operating a quantum computing system (QCS), according to various embodiments. The QCS may be similar to quantum computing system 100 of FIG. 1. Accordingly, the QCS includes a set of qubits. Each qubit of the set of qubits may be a physical qubit. The QCS may also include a set of couplers (e.g., qubit couplers). Method 320 begins at block 322, where an indication of a set of dropouts is received. Each dropout of the received set of dropouts corresponds to a qubit of the set of qubits that is a non-functional qubit or a coupler of the set of couplers that is a non-functional coupler. Thus, the set of dropouts defines a set of non-functional qubits, a set of functional qubits that is disjoint from the set of non-functional qubits, a set of non-functional couplers, and a set of functional couplers that is disjoint from the set of non-functional couplers.

At block 324, a quantum error correction (QEC) code is generated. Various embodiments of generating the QEC code are discussed in conjunction with method 340 of FIG. 3C. However, briefly here, generating the QEC code may be based on the set of dropouts and a set of heuristics. The QEC code operates on a first subset of the set of functional qubits. Each functional coupler of a first subset of the set of functional couplers provides a coupling between a separate pair of functional qubits of the first subset of functional qubits. At block 326, a quantum algorithm is executed on the QCS. Executing the quantum algorithm includes employing the QEC code to protect a set of logical qubits formed by the first subset of functional qubits from logical errors. In some embodiments, the set of dropouts includes a set of coupler dropouts corresponding to the set of non-functional couplers and a set of qubit dropouts corresponding to the set of non-functional qubits.

FIG. 3C depicts a flow chart diagram of an example method 340 for generating a quantum error correction (QEC) code, according to various embodiments. Method 340 begins at block 342, where additional qubit dropouts are added to the set of qubit dropouts based on the set of coupler dropouts and a first heuristic of the set of heuristics. At block 344, a set of boundaries of the QEC code is defined based on the set of qubit dropouts. The set of qubit dropouts is subdivided into a set of boundary dropouts and a set of bulk dropouts based on the set of boundaries. At block 346, at least a portion of the set of qubit dropouts is fused to a boundary of the set of boundaries. Various embodiments of fusing qubit dropouts to a boundary are discussed in conjunction with method 360 of FIG. 3D. At block 348, the QEC code is generated to exclude qubits of the set of qubits that correspond to the set of bulk dropouts and the set of boundary dropouts.

In some embodiments, each non-functional qubit of the set of non-functional qubits is deactivated. Likewise, each non-functional coupler of the set of non-functional couplers may be deactivated. The QEC code may subdivide the set of functional qubits into a set of data qubits and a set of check qubits that is disjoint from the set of data qubits. Each coupler of the set of couplers provides coupling between a data qubit of the set of data qubits and a check qubit of the set of check qubits. Each coupler of the set of couplers is associated with a data qubit of the set of data qubits and a check qubit of the set of check qubits.

In some embodiments, adding additional qubit dropouts to the set of qubit dropouts includes for each non-functional coupler of the set of non-functional couplers, selecting at least one qubit of the set of qubits. The at least one selected qubit is the data qubit associated with the non-functional coupler or the check qubit associated with the non-functional coupler. Selecting the at least one qubit is based on the first heuristic. For each non-functional coupler of the set of non-functional couplers, the at least one selected qubit may be deactivated. For each non-functional coupler of the set of non-functional couplers, a qubit dropout may be added to the set of qubits. The added qubit dropout corresponds to the selected at least one qubit.

In some embodiments, the first heuristic may include, for a non-functional coupler of the set of non-functional couplers, when at least one of the data qubit associated with the non-functional coupler or the check qubit associated with the non-functional coupler is a non-functional qubit of the set of qubits or is unused by the QEC code, selecting the at least one data qubit or the check qubit. When both of the data qubit and the check qubit is a functional qubit and is used by the QEC code and when a check operator associated with the check qubit has a weight of two, then selecting the check qubit. When both of the data qubit and the check qubit is a functional qubit and is used by the QEC code and when the operator associated with the check qubit has a weight different than two, then selecting the data qubit.

FIG. 3D depicts a flow chart diagram of an example method 360 for fusing qubit dropouts to boundaries of a quantum error correction (QEC) code, according to various embodiments. In some embodiments, the QEC code subdivides the set of data qubits into a set of corner qubits and a set of bulk qubits. Method 360 begins at block 362, where at least a portion of the qubit dropouts are subtracted from the set of qubit dropouts. At block 364, the set of corner qubits is updated. At block 366, the set of corner qubits is optimized.

In some embodiments, subtracting the portion of the qubit dropouts includes removing selected qubits from the set of functional qubits. Removing the selected qubits may break at least one code invariant of a set of code invariants of the QEC code. In these embodiments, the at least one broken code invariant may be iteratively repaired. Iteratively repairing the at least one broken code may include when a data qubit included in the set of functional qubits is unprotected by the QEC code, removing the data qubit from the set of functional qubits. Conflicts between pairs of check operators of the QEC code may then be resolved. Resolving the conflicts between pairs of check operators may include when a pair of check operators of the QEC code has a conflict, selecting one check operator of the pair of check operators based on a second heuristic of the set of heuristics. The selected check operator may be removed from the QEC code.

The pair of check operators may include a first check operator and second check operator. The conflict between the pair of check operators may include the first check operator anti-commuting with the second check operator. The second heuristic may include when the first check operator anti-commutes with a third check operator of the QEC code, selecting the first check operator. When the second check operator anti-commutes with the third check operator of the QEC code, the second check operator may be selected. The second heuristic may further include when both the first check operator and the second check operator commute with all other check operators of the QEC code, selecting the first check operator when removing the first check operator provides a higher code distance than removing the second check operator. When both the first check operator and the second check operator commute with all other check operators of the QEC code, selecting the second check operator when removing the second check operator provides a higher code distance than removing the first check operator.

Updating the set of corner qubits may include identifying a set of connected components of the QEC code. For each connected component of the set of components, a circumference of the connected component may be determined. A first connected component from the set of connected components may be selected. The circumference of the first connected component is greater than the circumference of each of the other connected components of the set of connected components. The QEC code may be updated by removing each of the connected components of the set of connected components except for the first connected component. The set of corner qubits may be updated based on the updated QEC code, a number of corner qubits in the set of corner qubits, and a third heuristic of the set of heuristics. The third heuristic may include when the number of corner qubits in the set of corner qubits is greater than four, removing a first portion of corner qubits from the set of corner qubits such that the number of corner qubits in the set of corner qubits is four. When the number of corner qubits in the set of corner qubits is less than four, adding a qubit of the set of functional qubits to the set of corner qubits such that the number of corner qubits in the set of corner qubits is four. Optimizing the set of corner qubits may include for each corner qubit of the set of corner qubits, computing a code distance estimate corresponding to a potential location obtained by removing a weight-two check operator that is incident on the qubit corner. A weight-two check operator may be removed when the code distance estimate for the corner qubit is greater than a current code distance for the QEC code.

As discussed throughout, the QEC code may be based on a surface code. Each qubit of the set of qubits may be a physical qubit. A set of code invariants for the QEC code may include that the QEC code includes a set of corner qubits with a cardinality of four. The QEC code may include a set of check operators. The set of code invariants for the QEC code may include that each check operator of the set of check operators commutes with each other check operator of the set of check operators.

### Example Modified QEC Codes

FIGS. 4-7 show various non-limiting examples of generating valid QEC codes, when dropouts are present in a 2D grid of qubits, according to the embodiments. Note that these are only examples, and the embodiments may vary. For instance, the “broken” surface codes of FIGS. 4-7 have a data qubit grid size of 5×5. The embodiments may be employed in scenarios with a data qubit grid size greater than 5×5.

FIG. 4 shows generating a modified surface code 410 on a set of qubits 400 that include dropouts, according to some loss-resistance embodiments. As shown in FIG. 4, the set of qubits 400 has a set of dropouts, similar to FIGS. 2B-3A. Also, similar to FIGS. 2B-3A, the key 452 is used to interpret the pattern of the set of dropouts. For purposes of illustration, the modified surface code 410 (e.g., with dropouts) may be compared to the surface code 210 (e.g., with no dropouts) of FIG. 2A. The set of dropouts includes a first broken qubit 402 (e.g., a bulk qubit in the unmodified surface code 210 of FIG. 2A) and a second broken qubit 404 (e.g., a (topological) corner qubit in the unmodified surface code 210 of FIG. 2A).

The modified surface code 410 has been generated via the embodiments of methods 320, 340, and 360 of FIGS. 3B-3D. The modified surface code 410 protects the logical qubit formed by the subset of qubits that the modified surface code 410 operates on. Various code invariants have been conserved (via methods 320, 340, and 360). For instance, the modified surface code 410 has four corner qubits: first topological corner qubit 412, second topological corner qubit 414, third topological corner qubit 416, and fourth topological corner qubit 418. Note that each of the four corner qubits are data qubits.

Another code invariant that is conserved in the modified surface code 410 is that each check operator commutes with each other check operator of the modified surface code 410. To accomplish this, gauge operators are formed and combined to create composite (or synthetic operators) that commute with all the other check operators. For instance, the modified surface code 410 includes a first Z-type gauge operator 422 and a second Z-type gauge operator 424, which in combination forms a Z-type composite (or synthetic) operator. Likewise, the modified surface code 410 also includes a first X-type gauge operator 426 and a second X-type gauge operator 428, which in combination forms a X-type composite (or synthetic) operator. The Z-type and X-type synthetic operators commute with all the other check operators of the modified surface code 410. For instance, the Z-type and X-type synthetic operators have four data qubits in common. As such, they commute. Accordingly, modified surface code 410 is a valid QEC code.

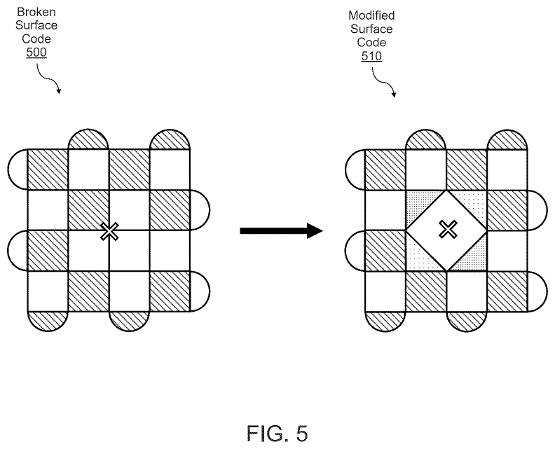

FIG. 5 shows generating a modified surface code 510 when dropouts are present, according to various embodiments. More particularly, FIG. 5 shows a broken surface code 500 due to a broken bulk data qubit. The various embodiments, via methods 320, 340, and 360 of FIGS. 3B-3D automatically generates modified surface code 510, which is “mapped around” the broken bulk data qubit and is a valid QEC code because it preserved the code invariants.

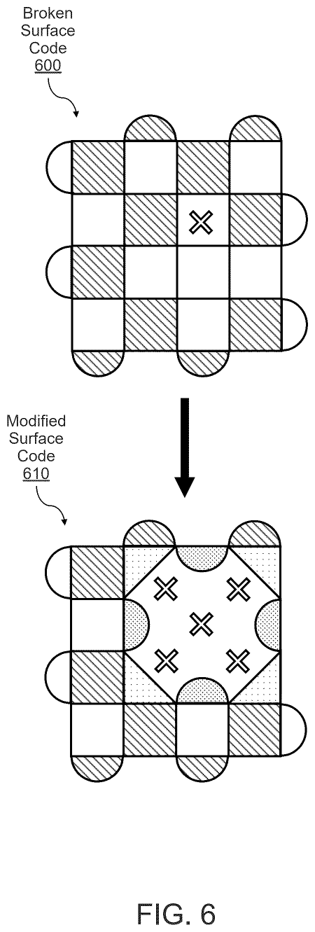

FIG. 6 shows generating another modified surface code 610 when dropouts are present, according to various embodiments. More particularly, FIG. 6 shows a broken surface code 600 due to a broken bulk check (or measure) qubit. The various embodiments, via methods 320, 340, and 360 of FIGS. 3B-3D automatically generate modified surface code 610, which is “mapped around” the broken bulk check qubit and is a valid QEC code because it preserved the code invariants. Note that in the modified surface code 610, some functional qubits are marked with an “X,” indicating that these functional qubits were inactivated and not employed in the modified surface code 610.

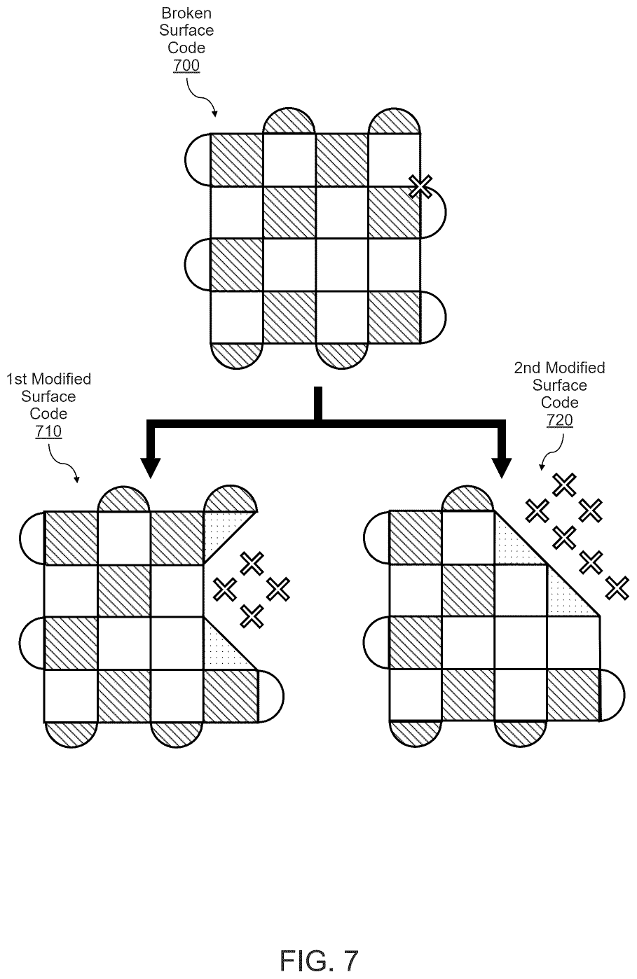

FIG. 7 shows generating a first modified surface code 710 and a second modified surface code 720 when dropouts are present, according to various embodiments. For some dropout patterns, the embodiments may generate multiple instances of valid modified surface codes. More particularly, FIG. 7 shows a broken surface code 700 due to a broken boundary data qubit. The various embodiments, via methods 320, 340, and 360 of FIGS. 3B-3D automatically generate a first modified surface code 710 and a second modified surface code 720, which are “mapped around” the broken boundary qubit. The two modified surface codes are valid QEC codes because they preserved the code invariants. Note that in both of the two modified surface codes, some functional qubits are marked with an “X,” indicating that these functional qubits were inactivated and not employed in the two modified surface codes. Note the first modified surface code 710 has a distance of d=4 and that the second modified surface code 720 has a distance of d=3. In such scenarios where multiple valid surface codes are generated, at least some embodiments will (automatically) select the surface code (out of the multiple valid surface codes) with the largest distance for deployment. Thus, some embodiments may automatically select the first modified surface codes 710 over the second modified surface code 720 for deployment.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them.

Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for operating a quantum computing system (QCS) that comprises a set of qubits and a set of couplers, wherein each coupler of the set of couplers provides a coupling between a separate pair of qubits of the set of qubits, the method comprising:
receiving an indication of a set of dropouts, wherein each dropout of the set of dropouts corresponds to a separate qubit of the set of qubits that is a non-functional qubit or a separate coupler of the set of couplers that is a non-functional coupler such that the set of dropouts defines a set of non-functional qubits, a set of functional qubits that is disjoint from the set of non-functional qubits, a set of non-functional couplers, and a set of functional couplers that is disjoint from the set of non-functional couplers;
generating a quantum error correction (QEC) code based on the set of dropouts and a set of heuristics, wherein the QEC code operates on a first subset of the set of functional qubits and each functional coupler of a first subset of the set of functional couplers provides a coupling between a separate pair of functional qubits of the first subset of functional qubits; and
executing, on the QCS, a quantum algorithm, wherein executing the quantum algorithm includes employing the QEC code to protect a set of logical qubits formed by the first subset of functional qubits from logical errors.

2. The method of claim 1, wherein the set of dropouts includes a set of coupler dropouts corresponding to the set of non-functional couplers and a set of qubit dropouts corresponding to the set of non-functional qubits, and generating the QEC code comprises:
adding additional qubit dropouts to the set of qubit dropouts based on the set of coupler dropouts and a first heuristic of the set of heuristics;
defining a set of boundaries of the QEC code based on the set of qubit dropouts, wherein the set of qubit dropouts is subdivided into a set of boundary dropouts and a set of bulk dropouts based on the set of boundaries;
fusing at least a portion of the set of qubit dropouts to a boundary of the set of boundaries; and
generating the QEC code to exclude qubits of the set of qubits that correspond to the set of bulk dropouts and the set of boundary dropouts.

3. The method of claim 2, further comprising:
deactivating each non-functional qubit of the set of non-functional qubits; and
deactivating each non-functional coupler of the set of non-functional couplers.

4. The method of claim 2, wherein the QEC code subdivides the set of functional qubits into a set of data qubits and a set of check qubits that is disjoint from the set of data qubits, and each coupler of the set of couplers provides coupling between a data qubit of the set of data qubits and a check qubit of the set of check qubits such that each coupler of the set of couplers is associated with a data qubit of the set of data qubits and a check qubit of the set of check qubits.

5. The method of claim 4, wherein adding additional qubit dropouts to the set of qubit dropouts comprises:
for each non-functional coupler of the set of non-functional couplers, selecting at least one qubit of the set of qubits, wherein the at least one qubit is the data qubit associated with the non-functional coupler or the check qubit associated with the non-functional coupler, wherein selecting the at least one qubit is based on the first heuristic;
for each non-functional coupler of the set of non-functional couplers, deactivating the at least one qubit; and
for each non-functional coupler of the set of non-functional couplers, adding a qubit dropout to the set of qubits, wherein the qubit dropout corresponds to the at least one qubit.

6. The method of claim 4, wherein the first heuristic comprises:
for a non-functional coupler of the set of non-functional couplers, when at least one of the data qubits associated with the non-functional coupler or the check qubit associated with the non-functional coupler is a non-functional qubit of the set of qubits or is unused by the QEC code, selecting the at least one data qubit or the check qubit;
when both of the data qubit and the check qubit is a functional qubit and is used by the QEC code and when a check operator associated with the check qubit has a weight of two, then selecting the check qubit; and
when both of the data qubit and the check qubit is a functional qubit and is used by the QEC code and when the operator associated with the check qubit has a weight different than two, then selecting the data qubit.

7. The method of claim 4, wherein the QEC code subdivides the set of data qubits into a set of corner qubits and a set of bulk qubits and fusing at least a portion of the set of qubit dropouts to a boundary of the set of boundaries comprises:
subtracting at least a portion of the qubit dropouts from the set of qubit dropouts;
updating the set of corner qubits; and
optimizing the set of corner qubits.

8. The method of claim 7, wherein subtracting the portion of the qubit dropouts comprises:
removing selected qubits from the set of functional qubits, wherein removing the selected qubits breaks at least one code invariant of a set of code invariants of the QEC code; and
iteratively repairing the at least one code invariant.

9. The method of claim 8, wherein iteratively repairing the at least one code invariant comprises:
when a data qubit included in the set of functional qubits is unprotected by the QEC code, removing the data qubit from the set of functional qubits; and
resolving conflicts between pairs of check operators of the QEC code.

10. The method of claim 9, wherein resolving the conflicts between pairs of check operators comprises:
when a pair of check operators of the QEC code has a conflict, selecting one check operator of the pair of check operators based on a second heuristic of the set of heuristics; and
removing the one check operator from the QEC code.

11. The method of claim 10, wherein the pair of check operators includes a first check operator and second check operator, the conflict between the pair of check operators includes the first check operator anti-commuting with the second check operator and the second heuristic comprises:
when the first check operator anti-commutes with a third check operator of the QEC code, selecting the first check operator; and
when the second check operator anti-commutes with the third check operator of the QEC code, selecting the second check operator.

12. The method of claim 11, wherein the second heuristic further comprises:
when both the first check operator and the second check operator commute with all other check operators of the QEC code, selecting the first check operator when removing the first check operator provides a higher code distance than removing the second check operator; and
when both the first check operator and the second check operator commute with all other check operators of the QEC code, selecting the second check operator when removing the second check operator provides a higher code distance than removing the first check operator.

13. The method of claim 7, wherein updating the set of corner qubits comprises:
identifying a set of connected components of the QEC code;
for each connected component of the set of components, determining a circumference of the connected component;
selecting a first connected component from the set of connected components, wherein the circumference of the first connected component is greater than the circumference of each of other connected components of the set of connected components;
updating the QEC code by removing each of the connected components of the set of connected components except for the first connected component; and
updating the set of corner qubits based on the updated QEC code, a number of corner qubits in the set of corner qubits, and a third heuristic of the set of heuristics.

14. The method of claim 13, wherein the third heuristic comprises:
when the number of corner qubits in the set of corner qubits is greater than four, removing a first portion of corner qubits from the set of corner qubits such that the number of corner qubits in the set of corner qubits is four; and
when the number of corner qubits in the set of corner qubits is less than four, adding a qubits of the set of functional qubits to the set of corner qubits such that the number of corner qubits in the set of corner qubits is four.

15. The method of claim 7, wherein optimizing the set of corner qubits comprises:
for each corner qubit of the set of corner qubits, computing a code distance estimate corresponding to a potential location obtained by removing a weight-two check operator that is incident on the qubit corner; and
removing a weight-two check operator when the code distance estimate for the corner qubit is greater than a current code distance for the QEC code.

16. The method of claim 1, wherein the QEC code is based on a surface code and each qubit of the set of qubits is a physical qubit.

17. The method of claim 1, wherein a set of code invariants for the QEC code includes that the QEC code includes a set of corner qubits with a cardinality of four.

18. The method of claim 1, wherein the QEC code includes a set of check operators and a set of code invariants for the QEC code includes that each check operator of the set of check operators commutes with each other check operator of the set of check operators.

19. A quantum computing system (QCS), comprising:
a set of qubits
a set of couplers, wherein each coupler of the set of couplers provides a coupling between a separate pair of qubits of the set of qubits;
one or more processor devices;
one or more memory devices, the one or more memory devices storing computer-readable instructions that when executed by the one or more processor devices cause the one or more processor devices to perform operations for operating the QCS, the operations comprising:
receiving an indication of a set of dropouts, wherein each dropout of the received set of dropouts corresponds to a qubit of the set of qubits that is a non-functional qubit or a coupler of the set of couplers that is a non-functional coupler such that the set of dropouts defines a set of non-functional qubits, a set of functional qubits that is disjoint from the set of non-functional qubits, a set of non-functional couplers, and a set of functional couplers that is disjoint from the set of non-functional couplers;
generating a quantum error correction (QEC) code based on the set of dropouts and a set of heuristics, wherein the QEC code operates on a first subset of the set of functional qubits and each functional coupler of a first subset of the set of functional couplers provides a coupling between a separate pair of functional qubits of the first subset of functional qubits; and
executing, on the QCS, a quantum algorithm, wherein executing the quantum algorithm includes employing the QEC code to protect a set of logical qubits formed by the first subset of functional qubits from logical errors.

20. The quantum computing system of claim 19, wherein the set of dropouts includes a set of coupler dropouts corresponding to the set of non-functional couplers and a set of qubit dropouts corresponding to the set of non-functional qubits, and generating the QEC code comprises:
adding additional qubit dropouts to the set of qubit dropouts based on the set of coupler dropouts and a first heuristic of the set of heuristics;
defining a set of boundaries of the QEC code based on the set of qubit dropouts, wherein the set of qubit dropouts is subdivided into a set of boundary dropouts and a set of bulk dropouts based on the set of boundaries;
fusing at least a portion of the set of qubit dropouts to a boundary of the set of boundaries; and
generating the QEC code to exclude qubits of the set of qubits that correspond to the set of bulk dropouts and the set of boundary dropouts.
